(19) United States
(12) Patent Application Publication
(10) Pub. No.: US 2014/0208883 A1
(43) Pub. Date: Jul. 31, 2014

(54) ARM ASSEMBLY FOR A PARALLEL ROBOT

(71) Applicant: Precision Machinery Research & Development Center, Taichung (TW)

(72) Inventors: Chun-Tsun Lin, Taichung (TW); Zi-Min Yi, Taichung (TW)

(73) Assignee: Precision Machinery Research & Development Center, Taichung (TW)

(21) Appl. No.: 13/974,262

(22) Filed: Aug. 23, 2013

(30) Foreign Application Priority Data
Jan. 28, 2013 (TW) 102103098

(51) Int. Cl. B25J 18/00

(52) U.S. Cl. CPC B25J 18/00; Y10S 901/27
USPC 74/490.05; 901/27

(57) ABSTRACT

An arm assembly includes three first arm units connected to a base frame of a parallel robot, a bracket unit disposed below and spaced apart from the base frame, and three second arm units. Each of the second arm units includes a first axle sub-unit journaled to a respective one of the first arm units, a pair of second axle sub-units connected to the first axle sub-unit, a fourth axle sub-unit journaled to the bracket unit, a pair of third axle sub-units connected to the fourth axle sub-unit, and a pair of rod members. Each of the rod members is connected to a respective one of the second axle sub-units and a respective one of the third axle sub-units.

### BACKGROUND OF THE INVENTION

1. Field of the Invention

The invention relates to a parallel robot, more particularly to an arm assembly for use in a parallel robot.

2. Description of the Related Art

Referring to FIGS. 1 and 2, a conventional parallel robot includes a base 10, three angularly spaced-apart driving motors 11 mounted on the base 10, and an arm assembly connected to the driving motors 11. The arm assembly includes three angularly spaced-apart upper arms 12, three angularly spaced-apart lower arms 13, and a bracket 14. The upper arms 12 are connected to and are driven rotatably by the driving motors 11, respectively. The bracket 14 is disposed below and is spaced apart from the base 10. Each of the lower arms 13 interconnects a respective one of the upper arms 12 and the bracket 14, and includes a pair of upper ball studs 131, a pair of lower ball studs 135, and a pair of connecting rods 133. The upper ball studs 131 of each of the lower arms 13 are connected to the respective one of the upper arms 12. The lower ball studs 135 of each of the lower arms 13 are connected to the bracket 14. For each of the lower arms 13, each of the connecting rods 133 has opposite ends provided respectively with sockets 132, 134 that are connected respectively to a respective one of the upper ball studs 131 and a respective one of the lower ball studs 135. As such, the articulations in the lower arms 13 of the conventional parallel robot are configured to be ball-and-socket joints.

In use, the bracket 14 of the conventional parallel robot is able to translate in three orthogonal directions by actuating the driving motors 11 for aiding mechanical machining of a workpiece placed thereon.

However, ball-and-socket joints are easily worn down to result in backlash, so that the movement of the bracket 14 may not be accurately conducted.

U.S. Pat. No. 5,333,514 discloses another conventional parallel robot that has similar articulations configured as ball-and-socket joints and that has drawbacks similar to those of the abovementioned conventional parallel robot.

### SUMMARY OF THE INVENTION

Therefore, the object of the present invention is to provide an arm assembly for use in a parallel robot and capable of providing precise mechanical machining after long-term use.

Accordingly, an arm assembly of the present invention for connection with a base frame of a parallel robot comprises a plurality of angularly spaced-apart first arm units, a plurality of angularly spaced-apart second arm units, and a bracket unit.

The first arm units are adapted to be connected rotatably to the base frame.

The bracket unit is disposed below and is spaced apart from the base frame.

Each of the second arm units is connected to a respective one of the first arm units and the bracket unit, and includes a first axle sub-unit, a pair of spaced-apart second axle sub-units, a pair of rod members, a pair of spaced-apart third axle sub-units, and a fourth axle sub-unit.

The first axle sub-unit is journaled to the respective one of the first arm units and has an axis extending along a first axial line.

The second axle sub-units are connected to the first axle sub-unit and have respective axes extending along second axial lines perpendicular to the first axial line.

The fourth axle sub-unit is journaled to the bracket unit, and has an axis extending along a fourth axial line parallel to the first axial line.

The third axle sub-units are connected to the fourth axle sub-unit, and have respective axes extending along third axial lines perpendicular to the fourth axial line.

Each of the rod members has one end portion connected to a respective one of the second axle sub-units and rotatable about the axis of the respective one of the second axle sub-units, and another end portion opposite to the one end portion, connected to a respective one of the third axle sub-units and rotatable about the axis of the respective one of the third axle sub-units.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional parallel robot;

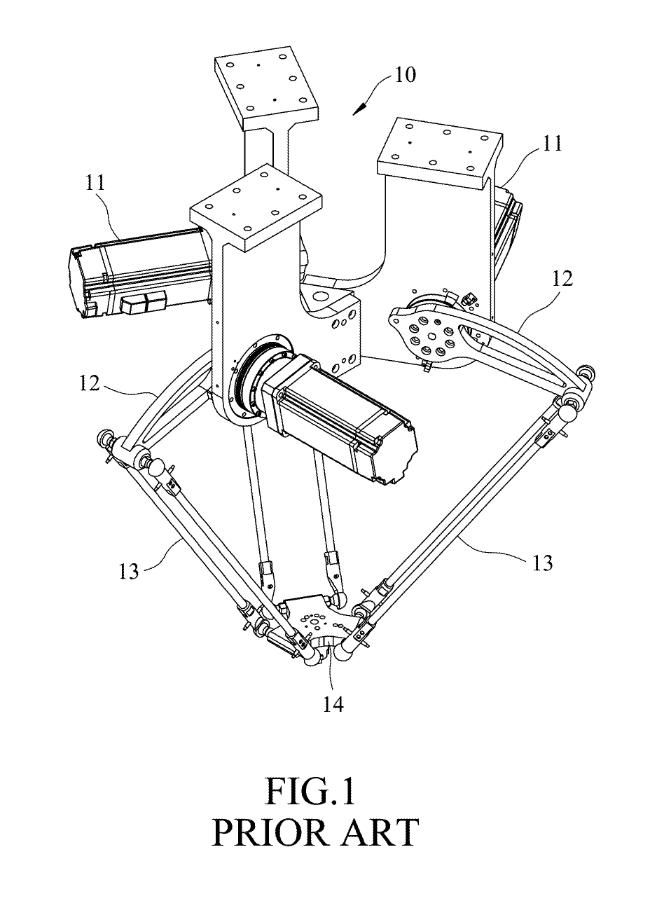

FIG. 2 is a fragmentary exploded perspective view of the conventional parallel robot;

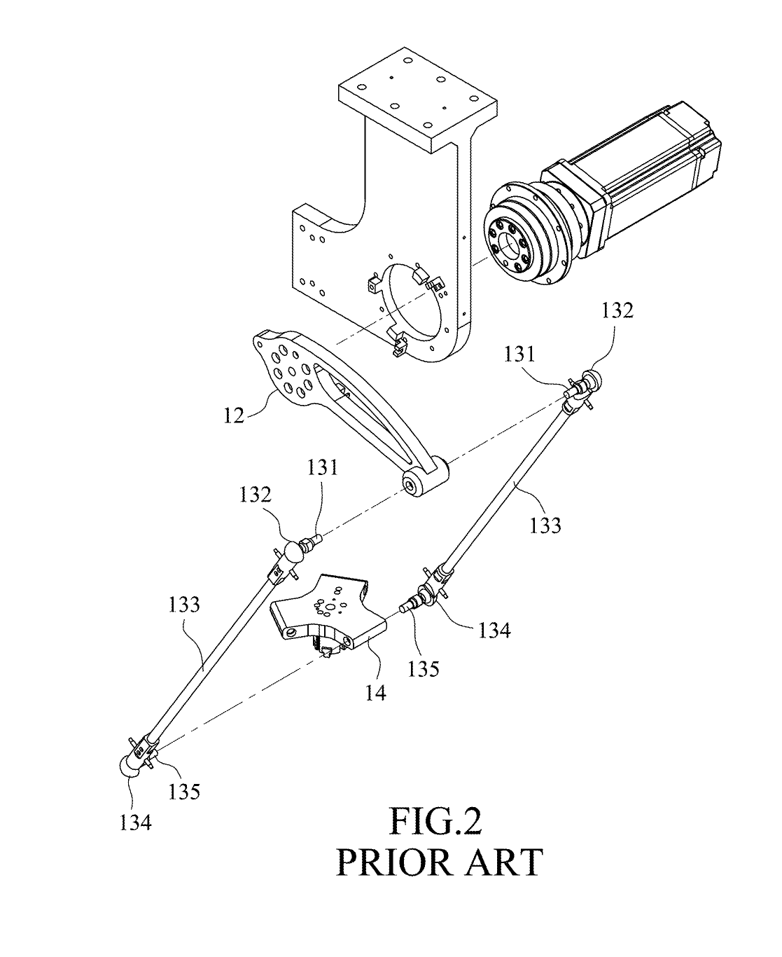

FIG. 3 is a perspective view of a parallel robot including a preferred embodiment of an arm assembly according to the invention;

FIG. 4 is a fragmentary perspective view of the parallel robot; and

FIG. 5 is a fragmentary exploded perspective view of the preferred embodiment.

### DETAILED DESCRIPTION OF THE PREFERRED EMBODIMENT

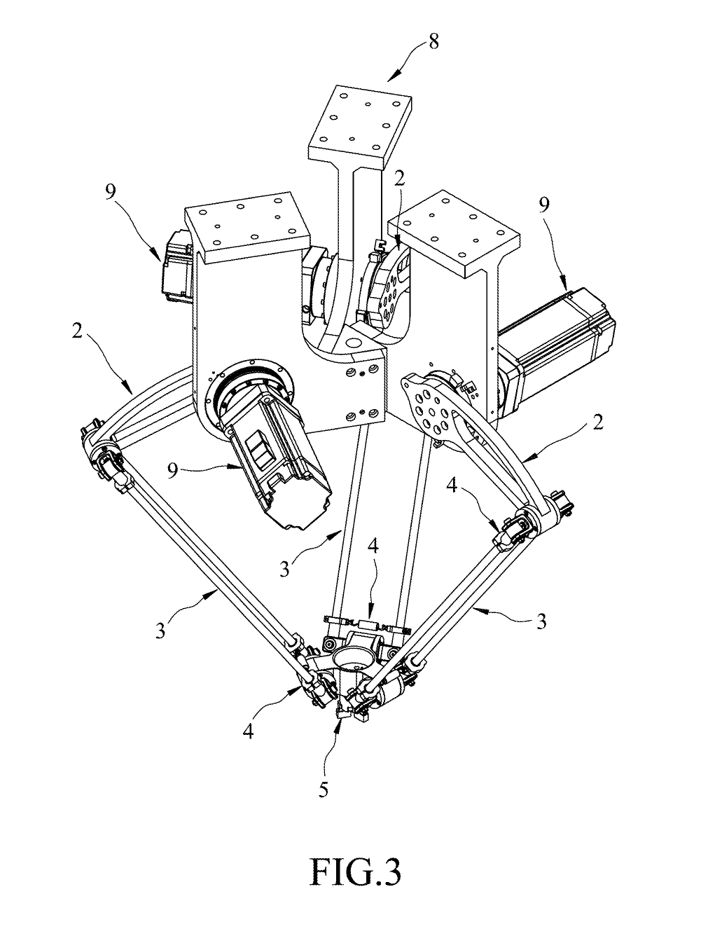

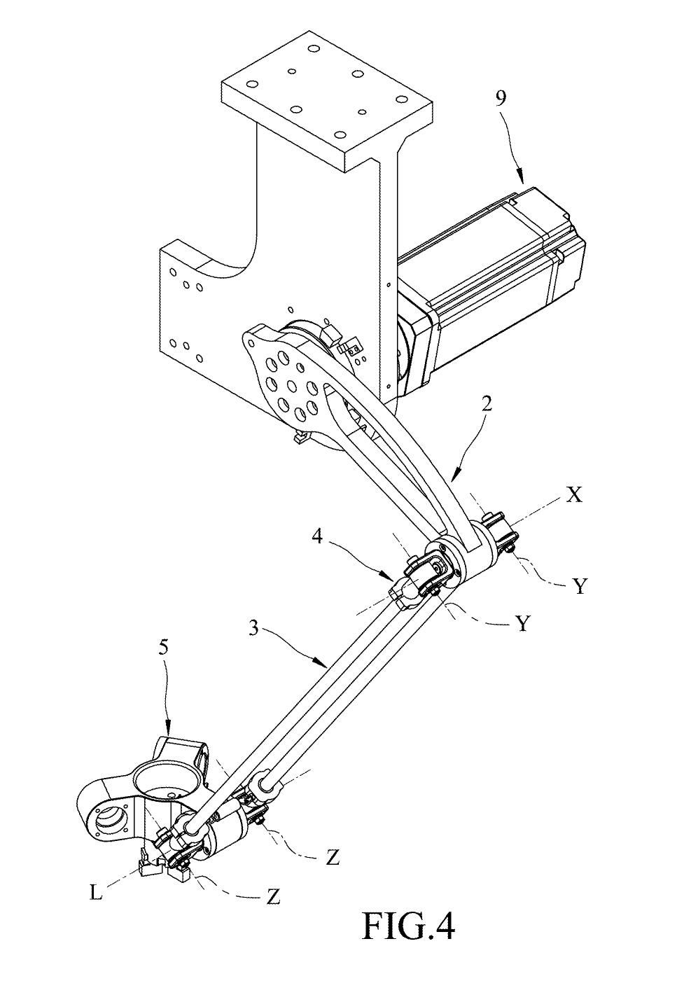

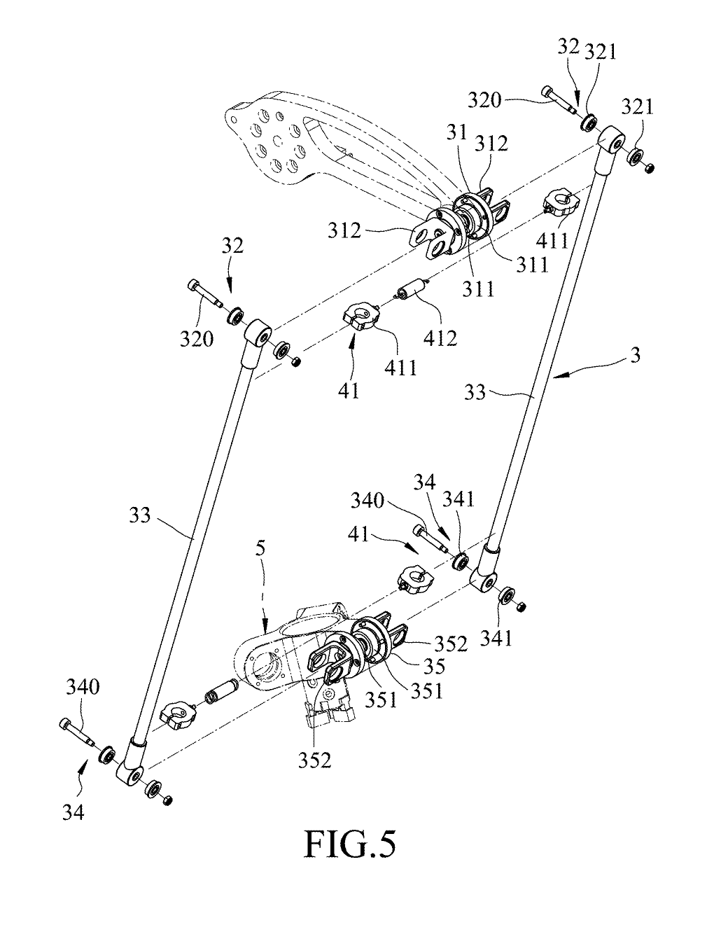

As shown in FIGS. 3 to 5, the preferred embodiment of an arm assembly according to the present invention is adapted for use in a parallel robot. The parallel robot includes a base frame 8 and three angularly spaced-apart driving motors 9 mounted on the base frame 8. The preferred embodiment comprises three angularly spaced-apart first arm units 2, three angularly spaced-apart second arm units 3, three preload units 4, and a bracket unit 5.

The first arm units 2 are connected to and are driven rotatably by the driving motors 9, respectively.

The bracket unit 5 is disposed below and spaced apart from the base frame 8.

Each of the second arm units 3 is connected to a respective one of the first arm units 2 and the bracket unit 5, and includes a first axle sub-unit 31, a pair of spaced-apart second axle sub-units 32, a pair of rod members 33, a pair of spaced-apart third axle sub-units 34, and a fourth axle sub-unit 35.

For each of the second arm units 3, the first axle sub-unit 31 is journaled to the respective one of the first arm units 2 and has an axis extending along a first axial line (X), the second axle sub-units 32 are connected respectively to opposite ends of the first axle sub-unit 31 and have respective axes extending along second axial lines (Y) which are perpendicular to the first axial line (X), the fourth axle sub-unit 35 is journaled to the bracket unit 5 and has an axis extending along a fourth axial line (L) which is parallel to the first axial line (X), and the third axle sub-units 34 are connected respectively to opposite ends of the fourth axle sub-unit 35 and have respective axes extending along third axial lines (Z) which are perpendicular to the fourth axial line (L). Each of the rod members 33 has one end portion connected to a respective one of the second axle sub-units 32, and another end portion opposite to the one end portion and connected to a respective one of the third axle sub-units 34.

In this embodiment, the first axle sub-units 31 of each of the second arm units 3 includes a pair of angular contact ball bearings 311 coupled together and journaled in the respective one of the first arm units 2, and a pair of upper axle support members 312 connected respectively to the angular contact ball bearings 311. Each of the upper axle support members 312 has a rod portion journaled in the respective one of the angular contact ball bearings 311, and a support portion serving as a respective one of the opposite ends of the first axle sub-units 31. The fourth axle sub-units 35 of each of the second arm units 3 includes a pair of angular contact ball bearings 351 coupled together and journaled in the bracket unit 5, and a pair of lower axle support members 352 connected respectively to the angular contact ball bearings 351. Each of the lower axle support members 352 has a rod portion journaled in the respective one of the angular contact ball bearings 351, and a support portion serving as a respective one of the opposite ends of the fourth axle sub-units 35.

For each of the second arm units 3, each of the second axle sub-units 32 is connected to a respective one of the upper axle support members 312, and includes a pair of ball bearings 321 journaled in the respective one of the upper axle support members 312, and a second axle member 320 journaled in the ball bearings 321. Each of the third axle sub-units 34 is connected to a respective one of the lower axle support members 352, and includes a pair of ball bearings 341 journaled in the respective one of the lower axle support members 352, and a third axle member 340 journaled in the ball bearings 341.

In this embodiment, for each of the second arm units 3, a distal end of the one end portion of each of the rod members 33 is connected to the second axle member 320 of the respective one of the second axle sub-units 32 and is rotatable about the axis of the respective one of the second axle sub-units 32, and a distal end of the another end portion of each of the rod members 33 is connected to the third axle member 340 of the respective one of the third axle sub-units 34 and is rotatable about the axis of the respective one of the third axle sub-units 34.

The preload units 4 are connected respectively to the second arm units 3. Each of the preload units 4 includes a pair of preload modules 41 that are respectively disposed near the first and fourth axle sub-units 31, 35 of the respective one of the second arm units 3. Each of the preload modules 41 of each of the preload units 4 includes a pair of clip members 411 that are connected respectively to the rod members 33 of the respective one of the second arm units 3, and an elastic connecting member 412 that interconnects the clip members 411 for biasing the clip members 411 toward each other.

In use, by virtue of the preload units 4, the rod members 33 of each of the second arm units 3 are biased toward each other. Therefore, through the second and third axle sub-units 32, 34, the angular contact ball bearings 311 of the first axle sub-unit 31 of each of the second arm units 3 are pressed tightly against each other, and the angular contact ball bearings 351 of the fourth axle sub-unit 35 of each of the second arm units 3 are pressed tightly against each other. As a result, backlash in the angular contact ball bearings 311 and backlash in the angular contact ball bearings 351 would be significantly reduced. Moreover, compared with ball-and-socket joints disclosed in the prior art, ball bearings are not easy to be worn down after long-term use. Therefore, a parallel robot using the preferred embodiment has a superior positioning accuracy in the movement of the bracket 5 than that of the conventional parallel robot.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An arm assembly for connection with a base frame of a parallel robot, comprising:
a plurality of angularly spaced-apart first arm units adapted to be connected rotatably to the base frame;
a bracket unit disposed below and spaced apart from the base frame; and
a plurality of angularly spaced-apart second arm units, each of said second arm units being connected to a respective one of said first arm units and said bracket unit, and including
a first axle sub-unit that is journaled to the respective one of said first arm units and that has an axis extending along a first axial line,
a pair of spaced-apart second axle sub-units that are connected to said first axle sub-unit and that have respective axes extending along second axial lines which are perpendicular to the first axial line,
a fourth axle sub-unit that is journaled to said bracket unit, and that has an axis extending along a fourth axial line which is parallel to the first axial line,
a pair of spaced-apart third axle sub-units that are connected to said fourth axle sub-unit, and that have respective axes extending along third axial lines which are perpendicular to the fourth axial line, and
a pair of rod members, each of which has one end portion connected to a respective one of said second axle sub-units and rotatable about the axis of the respective one of said second axle sub-units, and another end portion opposite to said one end portion, connected to a respective one of said third axle sub-units and rotatable about the axis of the respective one of said third axle sub-units.

2. The arm assembly as claimed in claim 1, further comprising a plurality of preload units connected respectively to said second arm units, each of said preload units including a pair of preload modules that are respectively disposed near said first and fourth axle sub-units of the respective one of said second arm units, each of said preload modules including a pair of clip members that are connected respectively to said rod members of the respective one of said second arm units, and an elastic connecting member that interconnects said clip members for biasing said clip members toward each other.

3. The arm assembly as claimed in claim 1, wherein, for each of said second arm units, said first axle sub-unit includes
a pair of angular contact ball bearings coupled together and journaled in the respective one of said first arm units, and
a pair of upper axle support members connected respectively to said angular contact ball bearings, said second axle sub-units being connected respectively to said upper axle support members.

4. The arm assembly as claimed in claim 3, wherein, for each of said second arm units, each of said second axle sub-units includes a pair of ball bearings journaled in the respective one of said upper axle support members of said first axle sub-unit.

5. The arm assembly as claimed in claim 1, wherein, for each of said second arm units, said fourth axle sub-unit includes
a pair of angular contact ball bearings coupled together and journaled in said bracket unit, and
a pair of lower axle support members connected respectively to said angular contact ball bearings, said third axle sub-units being connected respectively to said lower axle support members.

6. The arm assembly as claimed in claim 5, wherein, for each of said second arm units, each of said third axle sub-units includes a pair of ball bearings journaled in the respective one of said lower axle support members of said fourth axle sub-unit.

7. The arm assembly as claimed in claim 1, wherein, for each of said second arm units, a distal end of said one end portion of each of said rod members is connected to the respective one of said second axle sub-units and is rotatable about the axis of the respective one of said second axle sub-units, and a distal end of said another end portion of each of said rod members is connected to the respective one of said third axle sub-units and is rotatable about the axis of the respective one of said third axle sub-units.

8. The arm assembly as claimed in claim 1, wherein, for each of said second arm units, said second axle sub-units are connected respectively to opposite ends of said first axle sub-unit.

9. The arm assembly as claimed in claim 1, wherein, for each of said second arm units, said third axle sub-units are connected respectively to opposite ends of said fourth axle sub-unit.
